(19) United States
(12) Patent Application Publication
(10) Pub. No.: US 2004/0135095 A1
(43) Pub. Date: Jul. 15, 2004

(54) Gamma detecting discharge device and method of forming the same

(76) Inventor: Glenn Allen Holmquist, Idaho Falls, ID (US)

Correspondence Address: GLENN A. HOLMQUIST, 307 W 20th STREET, IDAHO FALLS, ID, 83402, US

(21) Appl. No.: 10/341,962

(22) Filed: Jan. 13, 2003

(51) Int. Cl. G01T 1/185

(52) U.S. Cl. 250/389

(57) ABSTRACT

A thin film ferroelectric/piezoelectric discharge device exhibits a stable high electrical resistance state. With an applied voltage, electron avalanche breakdown occurs and the device exhibits a low resistance state and recovers from this state. Thereby it is a solid state spark gap. With reduction of the voltage after breakdown the conduction of current ensues and contributes to the spontaneous recovery of the high resistive state evidenced by the measured increase in resistance in time. Gamma radiation ionization perturbs this recovery rate and this can be measured and differentiated from the conduction current induced resistance change. Thereby it is a room temperature gamma detector. The device is made by growing a controlled thickness of oxide on a titanium metal or alloy (12) surface (14) by anodization; heating in a metal oxide powder transforming the oxide into a ferroelectric/piezoelectric (16); and applying an electrode (18) to the exposed ferroelectric/piezoelectric surface.

### BACKGROUND OF THE INVENTION

The present invention generally relates to a discharge device using a solid ferroelectric/piezoelectric material, albeit a very thin film, as the non-destructive discharge material in the discharge device gap or space. The high electric field breakdown of this device results in poling the device at or before breakdown; the majority of the dielectric domains in the ferroelectric material are aligned by the applied field whereby the ferroelectric material becomes a piezoelectric material. The electrical resistance of the device, after high electric field breakdown, is altered when subject to electrical current conduction, and/or elevated temperature and/or gamma radiation. Reiterating, the present invention generally relates to titanium based composites and more particularly to titanium based composites exhibiting a high electric field breakdown, a spontaneous and incremental recovery from that breakdown and ferroelectric/piezoelectric properties.

### FIELD OF THE INVENTION: TITANIUM BASED COMPOSITE

The discharge device exhibits a high resistance stable state typical of a dielectric and/or ferroelectric material, and upon high voltage electron avalanche breakdown, the material exhibits a meta-stable low resistance state. It is observed that the transition is a reversible transition in lead titanate. The incremental breakdown is due to the characteristic way an applied voltage is opposed by an internal electric field in this ferroelectric/piezoelectric material. This incremental breakdown and spontaneous recovery characteristic is exploited in applications including a low voltage spark gap. The initial applied high breakdown field strength aligns the electric dipole moments in the material stabilizing to some degree the materials response to subsequent voltage applications. That is, the initial breakdown results in a poling phenomena changing the ferroelectric material to a piezoelectric material. This contributes to the reduction of fluctuation in the voltage of subsequent breakdowns.

The presently accepted interpretation is that the lead titanate's distorted tetragonal structure is further distorted in opposing an applied electric field and a resulting charge layer appears on the titanate side of the electrode creating a potential in opposition to the applied voltage. The field strength is very large at the ferroelectric/piezoelectric-electrode interface and is minimal in the interior of the ferroelectric/piezoelectric. As the applied voltage is increased the electron avalanche breakdown field strength is exceeded and breakdown occurs in the thin region at the electrode, but not through the bulk of the ferroelectric/piezoelectric. The thin breakdown region is then conductive, the process occurs again in the next thin layer of the non-conductive ferroelectric/piezoelectric. This proceeds stepwise across the material until the other electrode is reached. In this manner as the applied voltage is increased slowly the breakdown occurs in a repeatable stepwise manner. It is observed that the voltage of a slowly charging capacitor applied across a discharge device formed as described in this disclosure results in the device displaying controlled stepwise breakdown with breakdown voltages fluctuating little. This can be exploited in low voltage spark gap applications. It is observed that when the voltage change, increase, is rapid the breakdown voltages fluctuate greatly.

The incremental transition from the meta-stable low resistance state to the stable high resistance state can be exploited to use the discharge device as a room temperature gamma radiation detector. The electron avalanche breakdown creates a path of stationary ionized cations, that is, electrical defects, in the discharge device's atomic structure. This allows low resistance conduction via an electron hopping mechanism from electrical defect to electrical defect. At room temperature the limited random thermal electrons with limited mobility in the ferroelectric/piezoelectric slowly dissipate the ionized path in times of several days to weeks. At elevated temperature the ions in the path are neutralized or dispersed much more rapidly by the increased random creation of thermal electrons. The electric field of the ionized path attracts these thermal electrons whereupon they neutralize the ionized cations. This reduces the concentration of ions in the path, increasing the hopping distance hence increasing the resistance. This path is also neutralized over time by the random ionizing electron generating effects of gamma radiation at any temperature, including room temperature. Most important, this path can be neutralized over time at any temperature by capturing a small fraction of conduction electrons in a passing current. In this case the electrons do not appear randomly in the material but are local to the current path initially created by the electron avalanche breakdown. It is interpreted that the steady state dispersion of ions is reflected in the time rate of change of resistance of the discharge device. That is, the increase in time in the voltage drop across the discharge device at a constant current indicates the progress of the steady state ion neutralization/dispersion phenomena. It is experimentally observed that the dispersion of ions in the path by passing current is a steady state phenomena, a dynamic phenomena, and at room temperature a slow phenomena. The introduction of gamma radiation, a different source of electrons/ionization, changes or perturbs this current conduction dynamic steady state phenomena and this perturbation is indicated by a change in the resistance. This perturbation can be either a positive or negative change in the value of the resistance. Moreover, there is a time delay of several minutes for the perturbation to damp out at room temperature. If the steady state conditions are unchanged for tens of minutes before the gamma radiation level change the perturbation response is repeatable.

The manner to differentiate between the resistance change due to the passing current and the gamma radiation is straight forward. Specifically, the time rate of change of resistance due to the passing constant current is ten times perhaps several hundred times slower than the rate of resistance fluctuation due to a change in gamma radiation. This differential in the time response allows separation of the resistance changes due to the different effects. The sensitivity of the discharge device to gamma radiation level changes is not the focus of this disclosure. The demonstration with a one microCurie gamma source was and is necessary and sufficient to provide proof of principal of the gamma detection capability of this discharge device.

The titanium composite ferroelectric/piezoelectric materials in this invention are similar to titanium-titanate composites used in some thin film capacitors. Titanate dielectric capacitors have a maximum voltage rating above which they suffer electron avalanche breakdown, they lose their desirable capacitance characteristics and are a low resistance conductor. They become “shorted out.” It is common knowledge that some spontaneously recover after several days or weeks.

### DISCRIPTION OF THE RELATED ART: LOW VOLTAGE SPARK GAP APPLICATION

Recent advances in alternative energy technologies including photovoltaics (solar cells), thermoelectrics (thermocouples), radioisotope thermoelectric generators (nuclear heated thermocouples) and thermophotovoltaics (heated incandescent illumination of photovoltaics) are hindered as the power output is at a low voltage. Connecting multiple thermocouples or solar cells in series increases the voltage to a usable value. However, just like Christmas tree lights connected in series, “when one goes out, they all go out”. In the case of solar cells, if you shade one from the sun, the power from the entire series is reduced to little or no power. Connected in parallel this would not happen but the voltage would be difficult or impossible to utilize at a fraction of a volt. Therefore, it would be desirable to be able to provide a means for inexpensively, and efficiently boosting the fractional voltage of individual solar cells or small numbers of thermocouples to usable voltage values.

Typically spark gaps break down or discharge at thousands of volts. However, if a low voltage spark gap or discharge device is used in a voltage adder, for example a generic Marx generator circuit, the usable power would be repetitive power pulses at a higher voltage. A generic Marx generator circuit employs capacitors connected in series with spark gaps, a power supply charges the capacitors in parallel and they discharge through the spark gaps in series thereby adding their voltages. In this instance a small number of thermocouples or a solar cell are the power supplies for several Marx generators. In the event a thermocouple or solar cell is damaged or shaded from the sun the rest continue to provide all their power. Moreover, for the noted generic Mark generator circuit, the voltage is increased passively and efficiently without integrated circuits, oscillators and/or amplifiers.

A Marx generator is typically applied at voltages of thousands of volts because the spark gaps (millimeter air gap) in the circuit only operate at thousands of volts. Zener diodes can replace spark gaps for lower voltage use. The Zener diode operates at voltages greater than two volts; it exhibits very high resistance in the forward and reverse bias range of −2 to +2 volt. A Zener diode equipped Marx generator will not work at the low or fractional voltages achieved by thermocouples at small temperature differentials or a single photovoltaic solar cell. With this discharge device it is possible to operate a Marx generator at voltages as low as 0.3 volts. This can have important Homeland Security applications. For example, multiple thermocouple pairs on the exhaust pipes of a terrorist's automobile could power a discharge device equipped passive voltage adder to supply multi-watt pulses to a transmitter (bumper beeper) hidden under the car so as to locate the terrorist.

In direct thermal to electric conversion technologies the overall system efficiency of thermophotovoltaic generator technology and radioisotope thermoelectric generator technology could advantageously utilize the discharge device for improved efficiency and, in some cases, radiation hardness. Radioisotope thermoelectric generators, at an overall efficiency of ˜10%, are used as the only source of power in the Cassini space probe launched in 1997 and, operating well, it entered Jupiter's magnetosphere in January 2001 and will finish its journey at Saturn in 2004. This and other direct thermal to electric conversion technologies fall far short of the Carnot cycle conversion efficiency, the temperature reservoir differential imposed efficiency maximum of [1−(Tcold°K/Thot°K)]×100. Typical hot reservoir temperatures available from radioisotope thermal sources or sources on land sea, air and space platforms range between 573° K and 1273° K (300 and 1000 degrees centigrade). Typical cold reservoir temperatures are room temperature (295° K). Given this range of operating temperature theory predicts that conversion efficiencies greater than 50% should be achievable. However, demonstrated efficiencies have fallen far short of what theory predicts. This is partially due to inefficient voltage converters in these systems.

### SUMMARY OF THE INVENTION APPLICATION: LOW VOLTAGE SPARK GAP

The improved method of the present invention and the titanium-titanate composite produced by the method result in a discharge device that utilized as spark gaps in a voltage adder that would satisfy all the foregoing needs of the low voltage power generators. Conversely, without this low voltage discharge device invention in a voltage adder few or none of the foregoing needs could be satisfied. Applying this discharge device in a passive, efficient voltage adder represents an advancement to the state-of-the-art direct thermal to electric technologies that would reduce the gap between achievable conversion efficiencies and the Carnot efficiency maximum. The key to the utility of this invention is the discharge device's controlled breakdown and the spontaneous and timely recovery of the high resistance state, especially with the recovery modified by an applied current, a gamma radiation field at room temperature or an elevated temperature as low as 250 degrees centigrade. The method to fabricate the invention that displays controlled breakdown and spontaneous recovery capabilities is the first focus of this disclosure. The method to monitor the discharge device characteristics is the second focus of this disclosure. This discharge device formation method is simple, inexpensive and effective.

One last comment concerning radiation and the radiation hardness of this device. The radioisotope in the Cassini spacecraft emits only alpha radiation and the p-n junction power handling electronics are not threatened by the alpha. They would be damaged by gamma radiation. This discharge device invention is inherently more gamma radiation hardened than a p-n junction device. The gamma rays would necessarily contribute to the free electron generating ionization needed for high resistance state recovery. As a result a much greater variety of radioisotopes could be used in radioisotope generators if this discharge device system is substituted for the system presently used. That is, the gamma radiation that would destroy diodes or other power handling p-n junction devices would enhance the operation of this discharge device, not destroy it. Extending the thought, monitoring/detecting the gamma radiation enhanced operation would allow this discharge device to be used as a gamma detector.

### DISCRIPTION OF THE RELATED ART: GAMMA DETECTOR APPLICATION

Recent terrorist events have created a need to detect illicit trafficking of nuclear materials including uranium, plutonium and the constituents of a “dirty bomb” (radioactive materials dispersed by conventional explosives). U.S. Customs could use a very large number of cost effective alarms to annunciate the occasional need for more sophisticated and expensive radiation instruments and the personnel trained to use them. Reiterating, there is a need for a small, “dumb,” cost effective, lightweight, battery powered, low power consumption gamma radiation alarm. An alarm similar in size, weight and appearance to a household smoke detector. Discussions with a commercial radiation instrumentation representative revealed that there are “dumb” room temperature gamma detectors on the market (a plastic scintillator type—$4,000 from Can berra, Meridian CN). And some one could make a Geiger-Mueller tube instrument “dumb” but still at approximately $700. And the Can berra silicon diode detectors could be made without readouts at approximately $350. Depending on the electronics needed to overcome false positives with the sensitivity achievable, it may be possible to volume produce these “dumb” discharge device gamma alarms for sale at approximately $50 apiece. That is a guess, but not an unreasonable guess.

Presently available gamma detectors are scintillation counters necessitating heavy high voltage power supplies/batteries for the photomultiplier amplifiers, Geiger counters with high voltage power supplies/batteries for the Geiger-Mueller tube operation, germanium detectors necessitating large, heavy cryogenic systems to cool the Ge detectors, and the Can berra silicon diode detector. In their present state these are not amenable to untrained personnel. These are not amenable to an alarm weighing less than 16 ounces. These are not amenable to an alarm powered by a standard nine volt battery operating at tens of micro-watts power consumption levels. The radiation detection capabilities of scintillation counters, Geiger-Mueller tubes, germanium detectors and silicon diodes are much more discriminating and intelligent and sophisticated that this invention, but that degree of discrimination, intelligence and sophistication is not needed for the “first alert” type detection of “dirty bomb” materials or fissionable nuclear materials. Therefore, it would be desirable to provide a means to inexpensively, and efficiently form a discharge device operated as a gamma detector and incorporated into an alarm similar to a household smoke detector. Such an alarm indicates clearly to untrained personnel the occasional need for more sophisticated and expensive radiation measuring equipment and the personnel trained to use them.

### SUMMARY OF THE INVENTION: ROOM TEMPERATURE GAMMA DETECTOR APPLICATION

The improved method of the present invention and the titanium-titanate composite produced by this method result in a discharge device when used at room temperature in a gamma radiation alarm that would satisfy all the foregoing needs of a “smoke detector” like gamma alarm. The result can have important Homeland Security consequences. This would economically facilitate the dissemination of large numbers of these alarms throughout the United States and/or Russia aiding the identification/detection of the movement of “dirty bombs” or fissionable nuclear material. These alarms could be located at all customs inspection facilities, all cargo ports of entry, airports and perhaps delivery trucks thereby alerting authorities to the passage of these nuclear materials. If the alarm sounds, as with a smoke detector, an untrained person notifies the trained people with more sophisticated equipment.

Without this discharge device the foregoing “first alert” U.S. Customs needs, Homeland Security needs and the Department of Defense—Defense Threat Reduction Agency needs could not be satisfied in a cost effective manner. The method to fabricate the discharge device invention and the technique to measure the gamma radiation response is the crux of this patent application and these claims. This discharge device formation method is simple, inexpensive and effective.

### BRIEF DESCRIPTION OF THE DRAWINGS

A better understanding of the present invention may be gained from a consideration of

FIG. 1 which is an enlarged schematic cross-section of the preferred embodiment of the improved titanium composite of the present invention. It will be understood that the aspect ratio is not shown in true proportion in the figure and the thickness of the titanium metal or alloy, the ferroelectric layer and the electrode are exaggerated each to a different degree for clarity.

FIG. 2 is an alternative configuration of a preferred embodiment of the improved titanium composite of the present invention. Likewise the aspect ratio.

### DETAILED DESCRIPTION OF THE INVENTION

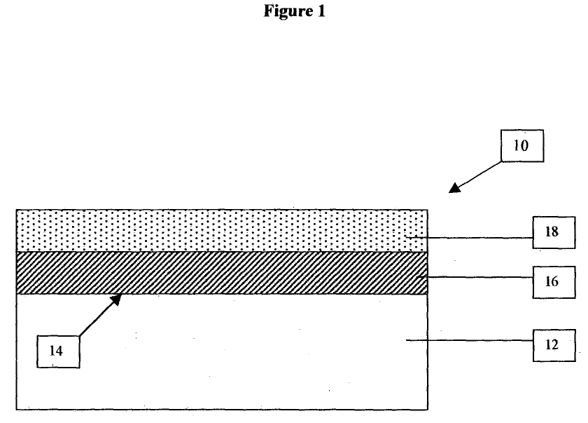

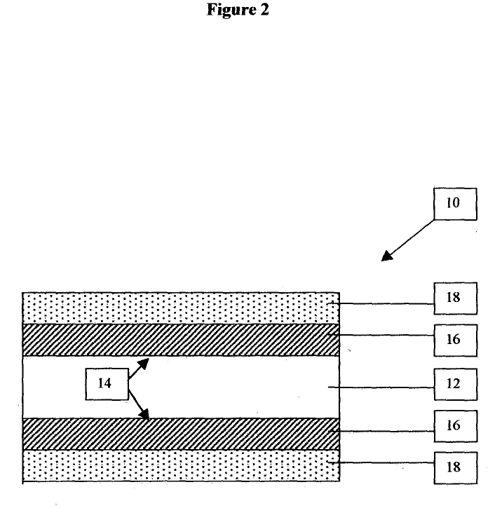

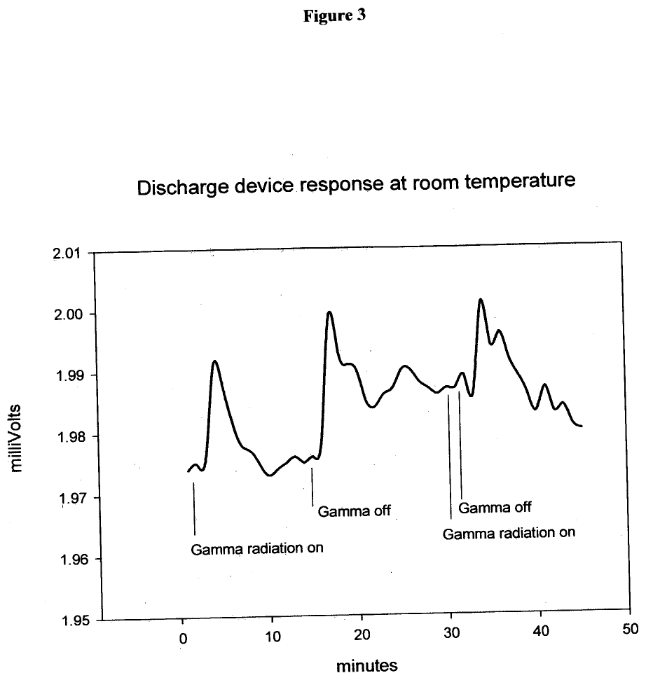

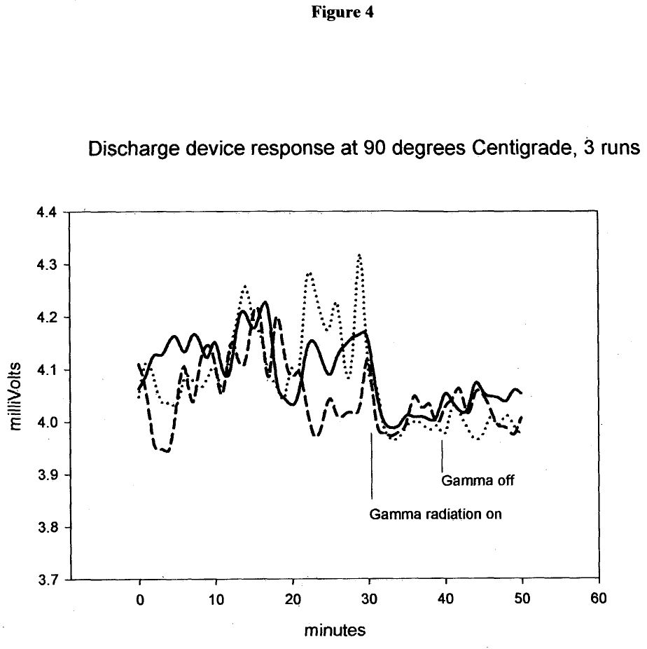

Preferred embodiments of the improved titanium composite or titanium alloy composite of the present invention are schematically depicted in FIGS. 1 and 2 of the accompanying drawings. Here is shown composite 10 which comprises titanium or a titanium alloy 12 having surface(s) 14 to which a ferroelectric/piezoelectric thin film 16 is tenaciously adhered. An electrode material 18, including but not limited to, conductive silver paint, is applied to the exposed surface of the ferroelectric/piezoelectric layer 16 and the metavalloy 12 forms the other electrode. It will be understood that layers 16 and 18 are not necessarily shown in true proportional thickness in the figure. The thickness of the ferroelectric/piezoelectric layer 16 is in proportion to the original titanium oxide thickness achieved by anodizing at a specific voltage. As the breakdown voltage of a ferroelectric/piezoelectric is in proportion to its thickness, the breakdown voltage of the resulting discharge device is in proportion to the original oxide layer thickness and therefore the original anodizing voltage. This ferroelectric/piezoelectric layer with a thickness controlled by the anodizing voltage is the material that forms the space or gap of the discharge device.

The improved formation method of the present invention is directed to the formation of the titanium composite or titanium alloy composite. The method comprises the following steps:

1. A fresh titanium or titanium alloy 12 metal surface 14 is exposed by, but not limited to, abrading to remove any natural oxidation or passivation layer that may be present on the metal or alloy.

2. The metal/alloy 12 is made the anode of an electrolytic cell and the metal surface 14 is oxidized by anodizing in a aqueous electrolyte of, but not limited to, 3% hydrogen peroxide, at voltages as low as 5 Volts, to form a hydrated oxide layer to a controlled thickness. As in the normal manner of anodization, the current flowing in the electrolytic cell decays as the oxide layer grows and limits further oxide growth. The anodization continues for 2 minutes per square centimeter of anodized surface area and is stopped.

3. Thereafter, without any other treatment the anodized metal is immersed or buried in a metal oxide powder contained in a crucible and fired to simultaneously drive off the waters of hydration and drive in the metal oxide with the formation of the ferroelectric/piezoelectric layer (16).

4. An electrode material (18), including but not limited to, conductive silver paint, is applied to the surface of the ferroelectric/piezoelectric layer, the metal/alloy is the other electrode.

5. Make the positive polarity electrical connection to the titanium or titanium alloy.

6. Make the negative polarity electrical connection to the ferroelectric/piezoelectric electrode.

It will be understood that the present method can be carried out utilizing parameters which differ somewhat from those specified above. Various other modifications, changes, alterations and additions in the present method, its steps and parameters and in the present composite can be made. All such modifications, changes, alterations and additions as are within the scope of the appended claims and form part of the present invention. It is understood that lead zirconate can be substituted in part or in whole for the lead titanate. Lead zirconate or lead zirconate-titanate exhibits ferroelectric and piezoelectric characteristics appropriate to this discharge device's operation including as a spark gap or as a gamma detector. Thusly, all such lead zirconate and lead titanate-zirconate materials are within the scope of the appended claims and form part of the present invention.

### EXAMPLE ONE

The following example further illustrates certain features of the processing method. It explores the variation of processing parameters on the electrical breakdown phenomena, that is, the discharge or spark gap breakdown voltage. Two samples of the alloy 90% titanium 6% aluminum 4% vanadium, each 18×30×1 mm in size, were treated similarly with the exception of the oxide dehydrating step. Sample A was dehydrated before packing powder firing; sample B was not and followed the procedure described in this patent application. Each was abraded on one side to expose a fresh metal surface. The samples, each in turn, were made the anode of an electrolytic cell. The electrolyte was 3% hydrogen peroxide (USP grade). The electrolytic cell cathode, a platinum ribbon, was configured in the electrolyte facing the fresh metal surface of the metal anode. A positive potential of 5 volts was supplied to the titanium alloy relative to the cathode. Anodization continued for 11 minutes. The anodized metal surface exhibited a pale yellow quarter wavelength interference color.

One sample, sample A, was heated on a hot plate to 450° C. for 4 minutes to effectively drive off the waters of hydration in the anodized oxide layer. The quarter wavelength interference color changed from yellow to blue, almost purple. Following the procedure in this patent application, sample B was not heated; sample B was not dehydrated; sample B remained a yellow color. The two samples were then buried (immersed) in lead II oxide powder contained in a crucible. The crucible was heated in an air furnace or kiln to 460±30° C. for 5 hours. The anodized layer on both samples changed appearance; the new color was a mottled gray. Lead titanate was the expected ferroelectric. Silver paint electrode dots 2 to 5 millimeters in diameter were painted on the ferroelectric surface.

The discharge devices are polar devices; the desired threshold breakdown is exhibited in only one polarity. The device exhibits a high resistance state with the silver/ferroelectric electrode biased negative (−cathode) and the titanium alloy biased positive (+anode). At increased voltages there is a resistance breakdown in the manner of a discharge device or spark gap. After the initial breakdown, and unavoidable poling, the breakdown voltages exhibited by sample A in consecutive tests were 5.2, 0.8, 2.7 and 2.9 volts. Sample B exhibited 1.0, 0.6, 0.9 and 0.8 volts. Sample A exhibited resistance on the order of tens of thousands of ohms, while the resistance of sample B was an order of magnitude smaller. Both exhibited elevated temperature recovery of the high resistance state after the applied breakdown voltage was removed.

Attempts to bias sample A at the threshold breakdown voltage resulted in the sample exhibiting either the high resistance or low resistance state and nothing in-between. However, when sample B was biased at its threshold breakdown voltage the current through the ferrroelectric/piezoelectric layer increased and decreased in observable jumps or steps. Sample B exhibited a dynamic state of transition. The observation of this phenomena and its utility in stabilizing the breakdown voltage (reduce jitter) are important to this invention. The characteristics of the resulting breakdown and its repeatability are well defined and to a high degree manageable. So much so as to allow this discharge device to be applied usefully in electrical and electronic devices. Conversely, ferroelectrics processed in a different manner do not easily exhibit stepwise breakdown without which they exhibit widely fluctuating breakdown voltages. This high degree of fluctuation prohibits normal discharge devices from being utilized in all but very simple devices or systems. It is concluded that both sample A and B could be used to form a discharge device, but the process described in this specification, that for sample B, yields an improved discharge device with more controlled characteristics, low breakdown voltages and lower breakdown voltage jitter.

### EXAMPLE TWO

The following example further illustrates certain features of the processing method. It explores the variation of processing parameters on the breakdown recovery phenomena, that is, the gamma radiation detecting capabilities of the discharge device. Two samples of the alloy 90% titanium 6% aluminum 4% vanadium, each 18×30×1 mm in size, were treated to form the ferroelectric layers on both sides of the sample, the configuration of FIG. 2, in the manner described in example one. Electrodes were applied on the exposed ferroelectric layer surfaces and electrically connected to each other. The metal sandwiched in between was electrically contacted. In this manner two layers of ferroelectric material were used essentially doubling the gamma detection capability of the device. The two samples, A and B, were processed similarly with the exception of the anodizing voltage. The electrolytic cell cathode, a noble metal, was configured in the electrolyte on both sides of the titanium alloy anode. A positive potential of 5 volts was supplied to sample A relative to the cathode. A positive potential of 12 volts was applied to sample B relative to the cathode. The anodization was stopped after a time equal to 2 minutes per square centimeter of anodized surface. The anodized metal surface of sample A, exhibited a pale yellow interference color. The anodized metal surface of the thicker ferroelectric layer, sample B, displayed a yellow-orange interference color. Lead titanate was formed in the lead (II) oxide powder firing step. Lead titanate was evidenced by the poling and piezoelectric behavior of the resulting material. A silver paint electrode was applied to the lead titanate surface covering 70% of the surface area and electrically connecting both sides of the sample. The ferroelectric film was ground off a 2×2 millimeter area exposing the underlying metal whereupon silver paint was applied making contact to the exposed metal. A voltage greater than the avalanche breakdown voltage was applied to the device (an over-voltage) and the avalanche breakdown was observed. The discharge device was biased at a constant 5 milliamps and the voltage was monitored. A four point probe technique was used to isolate the voltage measurement probes from the current source probes to reduce the error and the noise in the measurement. A constant current of 5 milliamps effected the steady state ion neutralization phenomena demonstrated by a slowly changing voltage drop across the discharge device on the order of 0.5 micro-Volts per minute. This is a resistance change of 0.1 milli-Ohm per minute. First, it is noted that the inherent noise in this measurement necessitates sampling over many tens of minutes to separate the resistance change with time from the noise in the measurement. Second, at 100 milliamps the measured change was measured to be 6 micro-Volts/minute but the signal-to-noise ratio of any perturbation is reduced at this higher current. At 5 milliamps constant current the change in the gamma radiation level (one microCurie source of Cobalt-60 located within four centimeters of the discharge device) demonstrated measurable fluctuations in the absolute value of the measured voltage (resistance). That is, the voltage change due to the gamma radiation level change was at least 2 times greater than the inherent fluctuation (noise) in the signal as shown in FIG. 3. The one micro-Curie cobalt-30 gamma source demonstrated proof of principal for the room temperature detection application of this discharge device.

### EXAMPLE THREE

A single sided discharge device was fabricated, over-voltage discharged, heated to 90 degrees centigrade, biased at a constant current and the response of three runs was measured as shown in FIG. 4. The elevated temperature is believed to cause the large fluctuation in the voltage signal over time. Gamma radiation from a one microCurie cobalt 60 calibration standard located 4 centimeters from the discharge device is introduced at 30 minutes and removed at 40 minutes. The fluctuation in the voltage measurement was decreased by the gamma radiation level change. After a few minutes the discharge device voltage fluctuation returned even while the gamma source continued to irradiate the device. There was no observable perturbation when the source was removed in contrast to example two at room temperature. No explanation is offered for the contrast. The observation is presented as another gamma detection capability of this discharge device.

Three Gamma Detection Modes

The discharge device in the low resistance state at room temperature will experience a slow steady state transition to the high resistance state as evidenced by its change in electrical resistance in time. This low resistance state can be attained at any time by discharging the discharge device at a voltage higher than the breakdown voltage. In this manner the device is maintained in the steady state transition for extended periods of time. This steady state condition in a lead titanate device will detect gamma radiation (changes) in three different modes. Two are demonstrated directly in this experimental work, the third indirectly.

Changes of low levels of gamma radiation are detected at room temperature as small perturbations in the measured resistance of the device. The perturbations are on the order of the noise level in the measured signal for a one microCurie cobalt-30 gamma source facilitated perturbation.

At temperatures on the order of 100 degrees centigrade, the background noise level in the resistance measurement is much greater than at room temperature and, using the Cobalt-60 source, a low level gamma radiation exposure results in a measurable reduction in the noise level of the measured signal.

High radiation levels were not available for testing, but it is assumed that high levels of radiation would promote lead titanate ionization of greater magnitude than that directly measured for low levels of radiation. It is reasoned that such high levels of radiation would promote lead titanate ionization to such a high degree the resistance change would become very rapid and the discharge device high resistance state would be achieved speedily, similar to recoveries occurring on the order of minutes as measured in this work in discharge devices heated to 300 degrees centigrade. This would represent a third detection mode sensitive to the presence, not just the change, in gamma radiation. That is, at sufficiently high radiation levels the resistance change due to the passing current would be overwhelmed by the resistance change due to the radiation.

What is claimed is:

1. a method of forming a titanium composite ferroelectric/piezoelectric discharge device or titanium alloy composite ferroelectric/piezoelectric discharge device by treating a titanium or titanium alloy having at least one exposed surface said method comprising the steps of:
a) treat at least one surface to remove essentially all the natural oxide coating and expose essentially a least one fresh metal surface.
b) anodize the exposed treated surface by making the metal the anode of an electrolytic cell whereby this process forms essentially a hydrated titanium oxide layer to a thickness in proportion to the applied voltage.
c) immerse/submerge the metal anodized on at least one side in a metal oxide powder and heat treat in an air furnace or kiln to transform essentially all the titanium oxide to the metal titanate ferroelectric/piezoelectric.
d) apply an electrode to the exposed ferroelectric/piezoelectric surface
e) make the positive polarity electrical connection to the titanium or titanium alloy.
f) make the negative polarity electrical connection to the ferroelectric/piezoelectric electrode.

2. a method of detecting gamma radiation with the formed discharge device said method comprising the steps of:
a) apply an impulse of voltage and electric charge to the discharge device to promote the discharge, reset or electron avalanche breakdown to form the low resistance state in the discharge device.
b) electrically bias the low resistive state discharge device monitoring the resistance amplitude and resistance change in time thereby facilitating gamma radiation detection.

3. the improved method of claim 1b wherein said electrolytic cell contains an electrolyte of, but not limited to, 3% hydrogen peroxide aqueous solution.

4. the improved method of claim 1b wherein the said metal is anodized at a voltage appropriate to form the desired oxide thickness.

5. the improved method of claim 1b wherein said anodization process shall continue for 2 minutes per square centimeter of anodized surface.

6. the improved method of claim 1b wherein said anodization process shall be immediately followed by said metal oxide powder firing of claim 1c without other heat treatment.

7. the improved method of claim 1c wherein the anodized metal is immersed in a lead (II) powder contained in a crucible and is heat treated until essentially all of the titanium oxide formed during the anodizing process has reacted to form essentially all the expected lead titanate and the titanium oxide is essentially absent in the composite, said heat treatment being effected at a temperature and for a time sufficient to assure the essentially complete utilization of the titanium oxide.

8. the improved method of claim 1d wherein the said electrode material is, but is not limited to, a colloidal silver metal suspension in an organic binder, that is, a conductive silver paint.

9. the improved method of claim 2a wherein the said discharge device receives the discharge of a capacitor charged to a voltage higher than the breakdown voltage and sufficient to create said low resistance state in the discharge device.

10. the improved method of claim 2a wherein the said discharge, reset or breakdown is achieved upon start up of this device and/or when an end point stable high resistance state is reached in normal operation.

11. the improved method of claim 2b wherein the said discharge device resistance at temperatures as low as room temperature is monitored by applying a current and monitoring the amplitude and rate of change in time of the voltage drop, hence the resistance, across the discharge device; or equivalently, measuring the resistance by applying a voltage and monitoring the amplitude and rate of change in time of the current through the discharge device.

12. the improved method of claim 2b wherein the said discharge device resistance at temperatures as low as room temperature facilitates said gamma detection in that, coupled with an increased rate of change with time, the resistance amplitude displays a change equal to or greater the inherent noise level in the monitored resistance.

13. the improved method of claim 2b wherein the said discharge device resistance at temperatures elevated above room temperature, but less than 350 degrees centigrade, facilitates said gamma radiation detection in that the background noise level in the measured resistance is measurably reduced in magnitude upon a change in the level of gamma radiation irradiating the discharge device.
